(19) United States
(12) Patent Application Publication
(10) Pub. No.: US 2025/0312845 A1
(43) Pub. Date: Oct. 9, 2025

(54) MIXTURE FOR FORMING A MULTILAYER INDUCTOR AND THE FABRICATION METHOD THEREOF

(71) Applicant: CYNTEC CO., LTD., HSINCHU (TW)

(72) Inventors: Chih Hung Wei, HSINCHU (TW); Chung Kai Liao, HSINCHU (TW)

(21) Appl. No.: 19/238,750

(22) Filed: Jun. 16, 2025

Related U.S. Application Data
(63) Continuation of application No. 17/720,278, filed on Apr. 13, 2022.
(60) Provisional application No. 63/174,551, filed on Apr. 14, 2021.

(51) Int. Cl. B22F 1/00; B22F 1/052; B22F 1/14; B22F 1/16; B22F 3/10; H01F 1/153; H01F 27/02; H01F 27/24; H01F 27/28; H01F 27/32; H01F 41/04; H01F 41/12

(52) U.S. Cl. CPC B22F 1/09; B22F 1/052; B22F 1/14; B22F 1/16; B22F 3/1007; H01F 1/153; H01F 27/022; H01F 27/24; H01F 27/2804; H01F 27/323; H01F 41/042; H01F 41/122; B22F 2301/35; B22F 2302/25; B22F 2302/45; B22F 2304/10; H01F 2027/2809

(57) ABSTRACT

A mixture for making a multilayer inductor, wherein the mixture comprises a first magnetic powder, a second magnetic powder, and a glass material, wherein each of the first magnetic powder and the second magnetic powder comprises an amorphous or nanocrystalline magnetic powder, wherein a softening point temperature of the glass material is in a range of 300°˜430° C.

### CROSS-REFERENCES TO RELATED APPLICATIONS

This application is a continuation of patent application Ser. No. 17/720,278 filed on Apr. 13, 2022, which claims the benefit of U.S. Provisional Patent Application No. 63/174,551 filed on Apr. 14, 2021, which is hereby incorporated by reference herein and made a part of the specification.

### BACKGROUND OF THE INVENTION

### I. Field of the Invention

The present invention relates to an ultra-low temperature sintered amorphous or nanocrystalline magnetic powder for making a multilayer inductor.

### II. Description of the Prior Art

In recent years, electronic products such as mobile devices have become thinner and smaller while their functionalities have kept increasing. As such, different voltages need to be generated from a battery of the mobile device so that the different voltages can be applied to different components, such as an LCD screen or wireless module in the mobile device. The multilayer inductor can be used in a DC-DC converter with the design goals including a lower direct-current resistance (DCR) and a higher power conversion efficiency.

The conventional multilayer power inductor made of iron alloy has moderate magnetic permeability with higher iron loss, which deteriorates the conversion efficiency of conversion circuits or DC-DC converters.

The conventional multilayer power inductor is sintered with atomized silver as the inner circuit, and the sintering temperature needs to be above 700° C. to achieve the effect of higher density and lower resistivity.

Accordingly, the present invention proposes a better way to design a multilayer inductor to overcome the above-mentioned problems.

### SUMMARY OF THE INVENTION

One objective of the present invention is to provide a mixture for making a multilayer inductor that can be formed at a lower temperature compared with conventional methods, wherein the mixture comprises low iron loss amorphous or nanocrystalline magnetic powder to improve the conversion efficiency of conversion circuits or DC-DC converters.

One objective of the present invention is to provide a mixture for making a multilayer inductor that can be sintered at a temperature not greater than 470° C.

One embodiment of the present invention is to provide a mixture for making a multilayer inductor, wherein the mixture comprises a first magnetic powder, a second magnetic powder, and a glass material, wherein each of the first magnetic powder and the second magnetic powder comprises an amorphous or nanocrystalline magnetic powder, wherein a softening point temperature of the glass material is in a range of 300°˜430° C.

In one embodiment, the first magnetic powder comprises Fe, Cr, Si, B, C.

In one embodiment, the second magnetic powder comprises Fe, Cr, Si, B, C.

In one embodiment, the D50 of the second magnetic powder is in a range of 1˜2 um.

In one embodiment, the glass material comprises a glass powder, wherein the D50 of the glass powder is not greater than 1 um.

In one embodiment, the D50 of the first magnetic powder is at least 7 times the D50 of the second magnetic powder.

In one embodiment, the glass material comprises Bi, Zn, B.

In one embodiment, the ratio of the volume of the second magnetic powder to the volume of the mixture is 20-40%.

In one embodiment, the weight of the first glass material relative to the total weight of the first magnetic powder and the first glass material is not greater than 4%.

In one embodiment, the weight of the second glass material relative to the total weight of the magnetic material is not greater than 8%.

In one embodiment, an oxide layer is coated on the surface of the second powder, wherein the thickness of the oxide layer is not greater than 10 nm.

In one embodiment, a mixture for making a multilayer inductor, said mixture comprising: a first magnetic powder, wherein the first magnetic powder comprises an amorphous or nanocrystalline magnetic powder; and a first insulating material, comprising a first glass material, wherein a softening point temperature of the glass material is in a range of 300°˜430° C., wherein the first insulating material is coated on an outer surface of each of a plurality of particles of the first magnetic powder to insulate each particle of the plurality of particles of the first magnetic powder.

In one embodiment, a second insulating material comprising a second glass material with a softening point in a range of 300°˜430° C. is filled in a space between the plurality of coated particles.

In one embodiment, the thickness of the first insulating material coated on the outer surface of each of a plurality of particles of the first magnetic powder is in a range of 20˜800 nm.

In one embodiment, the first insulating material comprises at least one of the following: SnO—P2O5, V2O5-TeO2, Bi2O3-B2O3, and ZnO.

In one embodiment, the weight of the first glass material relative to the total weight of the first magnetic powder and the first glass material is not greater than 4%.

In one embodiment, further comprising a second magnetic powder, wherein a second glass material fills into spaces among particles of the second magnetic powder and particles of the first magnetic powder.

In one embodiment, the first insulating material comprises glass powder, wherein the D50 of the glass powder is not greater than 1 um.

In one embodiment, the weight of the second glass material relative to the total weight of the magnetic material is not greater than 8%.

In one embodiment, the thickness of the first glass material coated on an outer surface of each of a plurality of particles of the first magnetic powder is not greater than 50 nm.

In one embodiment, a method to form a mixture for making a multilayer inductor is disclosed, wherein said method comprises: providing a first magnetic powder, wherein the first magnetic powder comprises an amorphous or nanocrystalline magnetic powder; and coating a first insulating material comprising a first glass material on an outer surface of each of a plurality of particles of the first magnetic powder to insulate each particle of the plurality of particles of the first magnetic powder, wherein a softening point temperature of the first glass material is in a range of 300°˜430° C.

In one embodiment, the method further comprising a filling process to fill a second magnetic powder and a second insulating material comprising a second glass material into a space between the plurality of coated particles of the first magnetic powder, wherein a softening point temperature of the second glass material is in a range of 300°˜430° C., and the second glass material is softened in the filling process for binding the first magnetic powder and the second magnetic powder.

In one embodiment, an electrical component is disclosed, the electrical component comprising: a plurality of magnetic layers stacked over one another, wherein for each magnetic layer, the magnetic layer comprises a magnetic powder, wherein the magnetic powder comprises an amorphous or nanocrystalline magnetic powder, wherein a first insulating material comprising glass with a softening point in a range of 300°˜430° C. is coated on an outer surface of each of a plurality of particles of the magnetic powder to insulate each particle of the plurality of particles of the magnetic powder, wherein a corresponding conductive pattern is disposed on each magnetic layer.

In one embodiment, the electrical component is an inductor, wherein the conductive patterns are used for forming a coil.

In one embodiment, a second insulating material comprising glass with a softening point in a range of 300°˜430° C. is filled in a space between the plurality of coated particles.

In one embodiment, the thickness of the first insulating material coated on the outer surface of each of a plurality of particles of the magnetic powder is in a range of 20˜800 nm.

In one embodiment, the first insulating material comprises at least one of the following: SnO—P2O5, V2O5-TeO2, Bi2O3-B2O3, and ZnO.

In one embodiment, the first insulating material is made of glass with a softening point in a range of 300°˜430° C.

In one embodiment, the first insulating material is made of glass with a softening point in a range of 330°˜430° C.

In one embodiment, the second insulating material is made of glass with a softening point in a range of 300°˜430° C.

In one embodiment, the second insulating material is made of glass with a softening point in a range of 330°˜430° C.

In one embodiment, the first insulating material and the second insulating material are identical.

In one embodiment, each of the first insulating material and the second insulating material is made of glass with a softening point in a range of 300°˜430° C.

The detailed technology and above preferred embodiments implemented for the present invention are described in the following paragraphs accompanying the appended drawings for people skilled in the art to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1A illustrates a first step to form a mixture for forming a magnetic layer of a multilayer inductor according to an embodiment of the present invention;

FIG. 1B illustrates a second step to form a mixture for forming a magnetic layer of a multilayer inductor according to an embodiment of the present invention;

FIG. 2A illustrates a cross-sectional view of a multilayer inductor structure according to an embodiment of the present invention;

FIG. 2B illustrate a cross-sectional view of a magnetic layer of the multilayer inductor structure according to an embodiment of the present invention; and

FIG. 2C illustrates a top view of the multilayer inductor structure according to an embodiment of the present invention.

### DETAILED DESCRIPTION OF THE INVENTION

The detailed explanation of the present invention is described as follows. The described preferred embodiments are presented for purposes of illustrations and description, and they are not intended to limit the scope of the present invention.

The present invention provides a mixture for making a multilayer inductor that can be formed at an ultra-low sintering temperature, wherein an oxide layer can be formed on the surface of particles of amorphous or nanocrystalline magnetic powder after heat treatment, or the surface of particles of amorphous and nanocrystalline powder can be at least partially coated with glass material by mechanical fusion method, wherein amorphous and nanocrystalline powder and glass material can be mixed according to different particle sizes and proportions. Then, the glue material can be removed under the air, and an oxide layer can be formed on the surface of particles of amorphous or nanocrystalline magnetic powder to increase the insulating strength of the magnetic powder. The mixture can be sintered under the nitrogen to bonded the glass material with the magnetic powders for increasing the sintering strength.

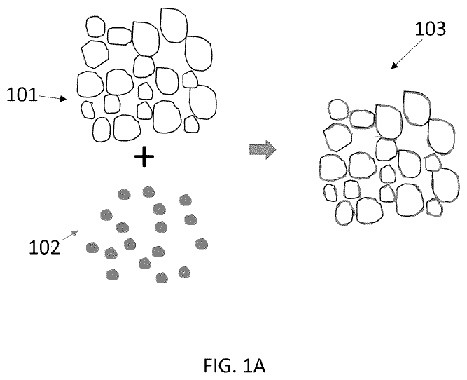

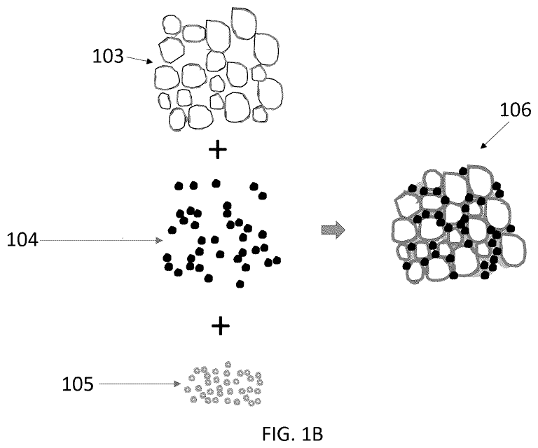

Please refer to FIG. 1A, which illustrates a method to form a mixture for making a multilayer inductor, said method comprising: providing a first magnetic powder 101, wherein the first magnetic powder 101 comprises an amorphous or nanocrystalline magnetic powder; and coating the first insulating material comprising a first glass material 102 on an outer surface of each of a plurality of particles of the first magnetic powder 101 to form the coated first magnetic powder 103, wherein a softening point temperature of the first glass material 102 is in a range of 300°˜430° C. In one embodiment, a softening point temperature of the first glass material 102 is in a range of 330°˜430° C.

Please refer to FIG. 1B, in one embodiment, the method further comprising a filling process to fill a second magnetic powder 104 and a second insulating material comprising a second glass material 105 into spaces between the plurality of particles of the coated first magnetic powder 103 to form a mixture 106, wherein a softening point temperature of the second glass material 105 is in a range of 300°˜430° C., and the second glass material is softened in the filling process for binding the plurality of particles of the coated first magnetic powder 103 and the second magnetic powder 104.

In one embodiment, oxygen is added in the process of burning and sintering a polymer material to form an oxide layer on the surface of the first magnetic powder to achieve insulation effect, wherein the weight of the oxygen is not greater than 20% relative to the weight of the polymer material.

In one embodiment, the second magnetic powder is heated before the filling process to add an oxide layer on the surface of each particle of the second magnetic powder, wherein the thickness of the oxide layer on the surface of the second magnetic powder is not greater than 10 nm

In one embodiment, a mixture for making a multilayer inductor is disclosed, wherein the mixture comprises a first magnetic powder, a second magnetic powder, and a glass material, wherein each of the first magnetic powder and the second magnetic powder comprises an amorphous or nanocrystalline magnetic powder, wherein a softening point temperature of the glass material is in a range of 300˜430° C.

In one embodiment, the first magnetic powder comprises Fe, Cr, Si, B, C.

In one embodiment, the second magnetic powder comprises Fe, Cr, Si, B, C.

In one embodiment, the D50 of the second magnetic powder is in a range of 1˜2 um, wherein D50 is the corresponding particle size when the cumulative percentage reaches 50%

In one embodiment, the glass material comprises a glass powder, wherein the D50 of the glass powder is not greater than 1 um.

In one embodiment, the D50 of the first magnetic powder is at least 7 times the D50 of the second magnetic powder.

In one embodiment, the glass material comprises Bi, Zn, B.

In one embodiment, a ratio of the volume of the second magnetic powder to the volume of the mixture is 20-40%.

In one embodiment, the weight of the first glass material relative to the total weight of the first magnetic powder and the first glass material is not greater than 4%.

In one embodiment, the weight of the second glass material relative to the total weight of the magnetic material is not greater than 8%.

In one embodiment, an oxide layer on the surface of each particle of the second magnetic powder, wherein the thickness of the oxide layer on the surface of the second magnetic powder is not greater than 10 nm.

In one embodiment, the first glass material can partially cover the first magnetic powder 103, and the second magnetic powder 104 and each of the first glass material 102 and the second glass material 105 can be in powder form for making a magnetic green sheet that can be used for making a multilayer inductor or a multilayer power inductor using a lamination method. The magnetic powder 103, the second magnetic powder 104, and the second glass powder 105 and an adhesive material can be uniformly mixed to form a slurry, and then spread the mixture spread on a carrier film through a blade forming process to obtain a magnetic green sheet.

In one embodiment, the adhesive material such as a glue material is 1.1˜2 wt % of the total weight of the mixture. If the adhesive material is not greater than 1.1 wt %, the green sheet structure is loose and inflexible; if the adhesive material is more than 2 wt %, the magnetic permeability will be reduced.

In one embodiment, the magnetic green sheets are stacked and punched to form a ring inductor with an outer diameter of 14 mm, an inner diameter of 8 mm with a thickness of 1˜3 mm.

In one embodiment, the magnetic green sheets are stacked and punched to form a ring inductor with an outer diameter of 14 mm, an inner diameter of 8 mm, and a thickness of 1 to 3 mm s, wherein the magnetic green sheet is formed by sintering the mixture in an atmosphere with an oxygen content greater than 20% and not greater than 470° C.

In one embodiment, the magnetic green sheets are stacked and punched to form 100-150 um sheets, wherein the magnetic green sheet is formed by sintering the mixture in an atmosphere with an oxygen content greater than 20% and not greater than 450° C.

In one embodiment, a mixture for making a multilayer inductor is disclosed, said mixture comprising: a first magnetic powder, wherein the first magnetic powder comprises an amorphous or nanocrystalline magnetic powder; and a first insulating material, comprising a first glass material, wherein a softening point temperature of the glass material is in a range of 300˜430° C., wherein the first insulating material is coated on an outer surface of each of a plurality of particles of the first magnetic powder to insulate each particle of the plurality of particles of the first magnetic powder.

In one embodiment, a second insulating material comprising a second glass material with a softening point in a range of 300° C. to 430° C. is filled in a space between the plurality of coated particles.

In one embodiment, the thickness of the first insulating material coated on the outer surface of each of a plurality of particles of the magnetic powder is in a range of 20˜800 nm.

In one embodiment, the first insulating material comprises at least one of the following: SnO—P2O5, V2O5-TeO2, Bi2O3-B2O3, and ZnO.

In one embodiment, the first insulating material comprises at least one of the following: SnO—P2O5, V2O5-TeO2, Bi2O3-B2O3,ZnO, and A2O—MoO3.

In one embodiment, the first insulating material is made of glass with a softening point in a range of 300° C. to 430° C.

In one embodiment, the second insulating material is made of glass with a softening point in a range of 300° C. to 430° C.

In one embodiment, the first insulating material and the second insulating material are identical.

In one embodiment, each of the first insulating material and the second insulating material is made of glass with a softening point in a range of 300° C. to 430° C.

In one embodiment, D50 of the first magnetic powder is in a range of 0.5˜40 um.

In one embodiment, the first magnetic powder comprises at least one of the following: Iron-silicon-boron-carbon-chromium-niobium-copper, iron-silicon-boron-carbon-chromium, iron-silicon-boron-carbon, iron-silicon-boron-carbon-chromium-niobium-phosphorus.

In one embodiment, further comprising a second magnetic powder, wherein D50 of the second magnetic powder is 1˜2 μm, and D50 of the first magnetic powder is at least 7 times D50 of the second magnetic powder.

In one embodiment, the ratio of the volume of the second magnetic powder to the volume of the mixture is 20-40%.

In one embodiment, the weight of the first glass material relative to the total weight of the first magnetic powder and the first glass material is not greater than 4%.

In one embodiment, further comprising a second magnetic powder, wherein a second glass material fills into spaces among particles of the second magnetic powder and particles of the first magnetic powder.

In one embodiment, the first insulating material comprises glass powder, wherein the D50 of the glass powder is not greater than 1 um.

In one embodiment, the weight of the second glass material relative to the total weight of the magnetic material is not greater than 8%.

In one embodiment, the thickness of the first glass material coated on the outer surface of the first magnetic powder is not greater than 50 nm.

In one embodiment, oxygen is added in the process of burning and sintering a polymer material to form an oxide layer on the surface of the first magnetic powder to achieve insulation effect, wherein the weight of the oxygen is not greater than 20% relative to the weight of the polymer material.

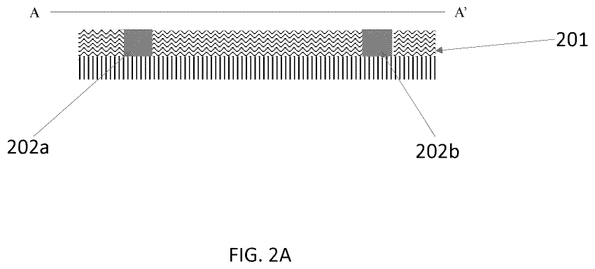

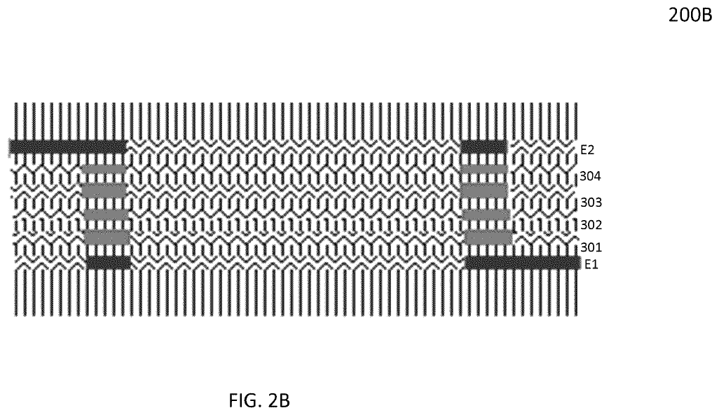

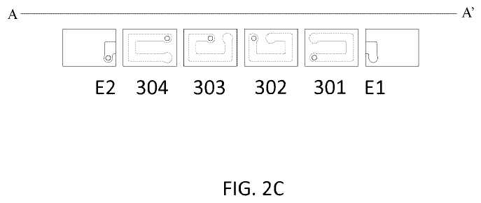

Please refer to FIG. 2A, which illustrates a cross-sectional view, along an A-A′ direction, of a structure 200A including a magnetic layer 201 for forming a coil, wherein the magnetic layer comprises a magnetic powder, wherein the magnetic powder comprises an amorphous or nanocrystalline magnetic powder, wherein a first insulating material comprising glass with a softening point in a range of 300° C. to 430° C. is coated on an outer surface of each of a plurality of particles of the magnetic powder to insulate each particle of the plurality of particles of the magnetic powder, wherein conductive patterns 202a, 202b are disposed on the magnetic layer for forming a coil.

In one embodiment, a trench can be formed in the magnetic layer 201, wherein conductive patterns 202a, 202b can be disposed in the trench of the magnetic layer for forming a coil.

FIG. 2B illustrates a cross-sectional view, along an A-A′ direction, of a structure 200B including a plurality of magnetic layers E1, 301,302, 303, 304, E2 for forming multilayer inductor having a coil, wherein for each magnetic layer, the magnetic layer comprises a magnetic powder, wherein the magnetic powder comprises an amorphous or nanocrystalline magnetic powder, wherein a first insulating material comprising glass with a softening point in a range of 300° C. to 430° C. is coated on an outer surface of each of a plurality of particles of the magnetic powder for insulating each particle of the plurality of particles of the magnetic powder, wherein a coil is disposed in the magnetic layer.

In one embodiment, a trench can be formed in each of the magnetic layers 301,302, 303, 304, wherein corresponding conductive patterns 202a, 202b can be disposed in a corresponding trench for forming a coil.

Please refer to FIG. 2C, which illustrates a top view, along an A-A′ direction, of the structure 200B, wherein a corresponding top view of each layer E2, 301,302, 303, 304, E1 is shown, wherein a coil is formed in the layers E2, 301,302, 303, 304, E1 for forming an inductor.

In one embodiment, an electrical component is disclosed, wherein the electrical component comprises: a plurality of magnetic layers stacked over one another, wherein for each magnetic layer, the magnetic layer comprises a magnetic powder, wherein the magnetic powder comprises an amorphous or aphanitic iron-based alloy, wherein a first insulating material comprising glass with a softening point in a range of 300° C. to 430° C. is coated on an outer surface of each of a plurality of particles of the magnetic powder to insulate each particle of the plurality of particles of the magnetic powder, wherein a corresponding conductive pattern is disposed on each magnetic layer.

In one embodiment, the electrical component is an inductor, wherein the conductive patterns form a coil.

In one embodiment, a second insulating material comprising glass with a softening point in a range of 300° C. to 430° C. is filled in a space between the plurality of coated particles.

In one embodiment, the thickness of the first insulating material coated on the outer surface of each of a plurality of particles of the magnetic powder is in a range of 20˜800 nm.

In one embodiment, the thickness of the first insulating material coated on the outer surface of each of a plurality of particles of the magnetic powder is not greater than 50 nm.

In one embodiment, the first insulating material comprises at least one of the following: SnO—P2O5, V2O5-TeO2, Bi2O3-B2O3, and ZnO.

In one embodiment, the first insulating material is made of glass with a softening point in a range of 300° C. to 430° C.

In one embodiment, the second insulating material is made of glass with a softening point in a range of 300° C. to 430° C.

In one embodiment, the first insulating material is made of glass with a softening point in a range of 330° C. to 430° C.

In one embodiment, the second insulating material is made of glass with a softening point in a range of 330° C. to 430° C.

In one embodiment, the first insulating material and the second insulating material are identical.

In one embodiment, each of the first insulating material and the second insulating material is made of glass with a softening point in a range of 300° C. to 430° C.

The above disclosure is related to the detailed technical contents and inventive features thereof. People skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mixture for making a multilayer inductor, wherein the mixture comprises a first magnetic powder, a second magnetic powder, a first glass material, and a second glass material, wherein the D50 of the first magnetic powder is greater than the D50 of the second magnetic powder, and each of the first magnetic powder and the second magnetic powder comprises an amorphous or a nanocrystalline magnetic powder, wherein the first glass material comprising SnQ-P2O5, V2O5-TeO2 or Bi2O3-B2O3 is coated on an outer surface of each of a plurality of particles of the first magnetic powder, wherein a softening point temperature of the first glass material is in a range of 300°˜430° C., and a softening point temperature of the second glass material is in a range of 300°˜430° C., wherein the second magnetic powder and the second glass material are filled into spaces between the plurality of coated particles of the first magnetic powder to form the mixture for making the multilayer inductor, wherein the second glass material is filled into a space between a first particle of the first magnetic powder and a second particle of the second magnetic powder with said first particle being coated with the first glass material, wherein the second glass material is softened for binding the first magnetic powder and the second magnetic powder.

2. The mixture as claimed in claim 1, wherein the mixture further comprises a conductive pattern therein.

3. The mixture as claimed in claim 1, wherein the mixture is then sintered in an atmosphere at a temperature greater than the softening point temperature of the second glass material but not greater than 470° C.

4. The mixture as claimed in claim 1, wherein a weight of the second glass material relative to a total weight of the first magnetic powder and the second magnetic powder is not greater than 8%.

5. The mixture as claimed in claim 1, wherein the D50 of the first magnetic powder is at least 7 times the D50 of the second magnetic powder.

6. The mixture as claimed in claim 1, wherein the first glass material and the second glass material are identical, wherein the second glass material comprising SnO—P2O5, V2O5-TeO2 or Bi2O3-B2O3 is softened for binding the first magnetic powder and the second magnetic powder.

7. The mixture as claimed in claim 1, wherein a ratio of a volume of the second magnetic powder to a total volume of the mixture is 20-40%.

8. The mixture as claimed in claim 1, wherein a thickness of the first glass material coated on an outer surface of each of a plurality of particles of the first magnetic powder is not greater than 50 nm.

9. The mixture as claimed in claim 1, wherein an oxide layer is coated on an outer surface of the second magnetic powder, wherein a thickness of the oxide layer is not greater than 10 nm.

10. A method to form a mixture for making a multilayer inductor, said method comprising:
providing a first magnetic powder, wherein the first magnetic powder comprises an amorphous or a nanocrystalline magnetic powder;
coating a first glass material comprises SnO—P2O5, V2O5-TeO2, or Bi2O3-B2O3 on an outer surface of each of a plurality of particles of the first magnetic powder, wherein a softening point temperature of the first glass material is in a range of 300°˜430° C.;
performing a filling process to fill a second magnetic powder, a second glass material and an adhesive material into a space between the plurality of coated particles of the first magnetic powder to form the mixture for making the multilayer inductor, wherein the D50 of the first magnetic powder is greater than the D50 of the second magnetic powder, and a softening point temperature of the second glass material is in a range of 300°˜430° C.; and
performing a sintering process to soften the second glass material for binding the first magnetic powder and the second magnetic powder, wherein the adhesive material is removed.

11. The method as claimed in claim 10, wherein the adhesive material is 1.1˜2 wt % of the total weight of the mixture before performing the sintering process.

12. The method as claimed in claim 10, wherein the mixture is then sintered in an atmosphere at a temperature greater than the softening point temperature of the second glass material but not greater than 470° C.

13. The method as claimed in claim 10, wherein a weight of the second glass material relative to a total weight of the first magnetic powder and the second magnetic powder is not greater than 8%.

14. The method as claimed in claim 10, wherein the D50 of the first magnetic powder is at least 7 times the D50 of the second magnetic powder.

15. The method as claimed in claim 10, wherein the first glass material comprises a first glass powder, wherein the D50 of the first glass powder is not greater than 1 um.

16. The method as claimed in claim 10, wherein the first glass material and the second glass material are identical, wherein the second glass material comprising SnO—P2O5, V2O5-TeO2 or Bi2O3-B2O3 is softened for binding the first magnetic powder and the second magnetic powder.

17. The method as claimed in claim 10, wherein the mixture further comprises a conductive pattern therein.

18. The method as claimed in claim 10, wherein a ratio of a volume of the second magnetic powder to a total volume of the mixture is 20-40%.

19. The method as claimed in claim 10, wherein a thickness of the first glass material coated on an outer surface of each of a plurality of particles of the first magnetic powder is not greater than 50 nm.

20. The method as claimed in claim 10, wherein an oxide layer is coated on an outer surface of the second magnetic powder, wherein a thickness of the oxide layer is not greater than 10 nm.
